(19) United States
(12) Patent Application Publication
(10) Pub. No.: US 2013/0107756 A1
(43) Pub. Date: May 2, 2013

(54) Method of Generating Access Point Scanning Order

(71) Applicant: Cheng-Chia Lai, New Taipei City (TW)

(72) Inventor: Cheng-Chia Lai, New Taipei City (TW)

(21) Appl. No.: 13/402,872

(22) Filed: Feb. 23, 2012

(30) Foreign Application Priority Data
Oct. 26, 2011 (TW) 100138836

(51) Int. Cl. H04W 84/12

(52) U.S. Cl. 370/255

(57) ABSTRACT

The present invention discloses a method of access point scanning order and related mobile communication device for a mobile communication device in a wireless local area network is disclosed. The method includes performing a computing procedure to a connection data corresponding to a plurality of access points to generate a computing result, and establishing a scanning order table according to the computing result, so as to perform a scanning procedure according to the scanning order table.

### BACKGROUND OF THE INVENTION

1. Field of the Invention

The present invention relates to a method of generating access point scanning order and related mobile communication device, and more particularly, to a method of generating access point scanning order and related mobile communication device that determine scanning priority according to connection data of access points.

2. Description of the Prior Art

As wireless communication technology becomes popular, it is common to dispose wireless access points (APs) in public areas such as an office, a library and a coffee shop to provide Internet service, and even in private areas, users may access the Internet through the wireless access point in every corner of their homes. Therefore, mobile communication devices, e.g. laptops or mobiles, of users may find many access points within a scanning range. When the users desire to access the Internet service, the mobile communication device performs a link procedure with the access point according to IEEE 802.11 wireless communication standards. A standard link procedure includes three stages, which are Scanning, Authentication and Association.

In general, there are two scanning types, i.e. passive scanning and active scanning, for a mobile communication device to discover surrounding APs. During the passive scanning, the APs periodically transmit beacon frames within one beacon interval. Since different APs may utilize different broadcast channels to transmit the beacon frames, the mobile communication device listens to the beacon frames from channel 1 to channel 11 to access required link information for establishing the link with the APs. The link information may include SSID (Service Set Identifier), support rate, TIM (Traffic Indication Map) and so on. On the other hand, during the active scanning, the mobile communication device transmits a broadcast probe request from channel 1 to channel 11 to ask for probe responses from the APs. In such a manner, using either passive or active scanning, the mobile communication device and the APs transmit packets, i.e. beacon frame, probe request and probe response, to communicate with each other and access the required link information.

However, as WLAN becomes popular, there may exist many mobile communication devices and many APs simultaneously transmitting packets within the same scanning range, which causes an increased probability of packet collision, and extends scanning time of the mobile communication device. On the other hand, the mobile communication device must listen to beacon frames or transmit the probe request from channel 1 to channel 11 to finish a completed scanning procedure, and obtain the link information of all APs in all channels. If no APs exist in some channels, the traditional scanning method wastes time scanning unused channels, or the mobile communication device wastes time scanning unwanted APs.

Therefore, in order to shorten link time and have better scanning efficiency, there is a need to improve the prior art.

### SUMMARY OF THE INVENTION

It is therefore an object of the present invention to provide a method of generating access point scanning order and related mobile communication device determining a scanning priority according to connection data of access points.

An embodiment of the invention discloses a method of generating an access point scanning order for a mobile communication device in a wireless local area network, the method including performing a computing procedure on connection data corresponding to a plurality of access points to generate a computing result, and establishing a scanning order table according to the computing result to perform a scanning procedure according to the scanning order table.

An embodiment of the invention further discloses a mobile communication device for a wireless local area network, including a processor, a memory, for storing a program code, the program code instructing the processor to execute the following steps: performing a computing procedure on connection data corresponding to a plurality of access points to generate a computing result, and establishing a scanning order table according to the computing result to perform a scanning procedure according to the scanning order table.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communication system according to an embodiment of the invention.

FIG. 2 is a schematic diagram of a mobile communication device shown in FIG. 1.

FIG. 3 is a schematic diagram of a process according to an embodiment of the invention.

### DETAILED DESCRIPTION

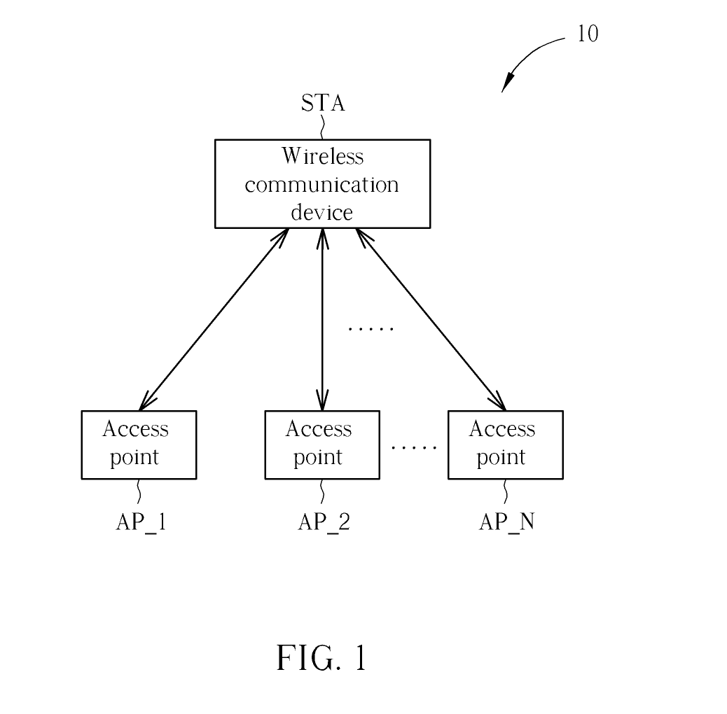

Please refer to FIG. 1, which is a schematic diagram of a wireless communication system 10 according to an embodiment of the invention. The wireless communication system 10 conforms to IEEE 802.11 wireless communication standards, and operates between different mobile devices, a wireless service provider, the Internet, areas and telecommunication operators. The wireless communication system 10 includes a mobile communication device STA and access points AP_{—}1-AP_N. The access points AP_{—}1-AP_N offer Internet services, such that users surf web pages, search information and download multimedia files through the mobile communication device STA. The mobile communication device STA may be any electronic device having wireless communication functions, such as a mobile phone, laptop, PDA and so on. When the user turns on the wireless communication function to access the Internet, the mobile communication device STA automatically scans the access points within its scanning range, and the user selects one of the scanned access points AP_{—}1-AP_N to link with the mobile communication device STA. After the link procedure is completed, the user can access the service from the Internet by wireless linkage between the mobile communication device STA and the access point.

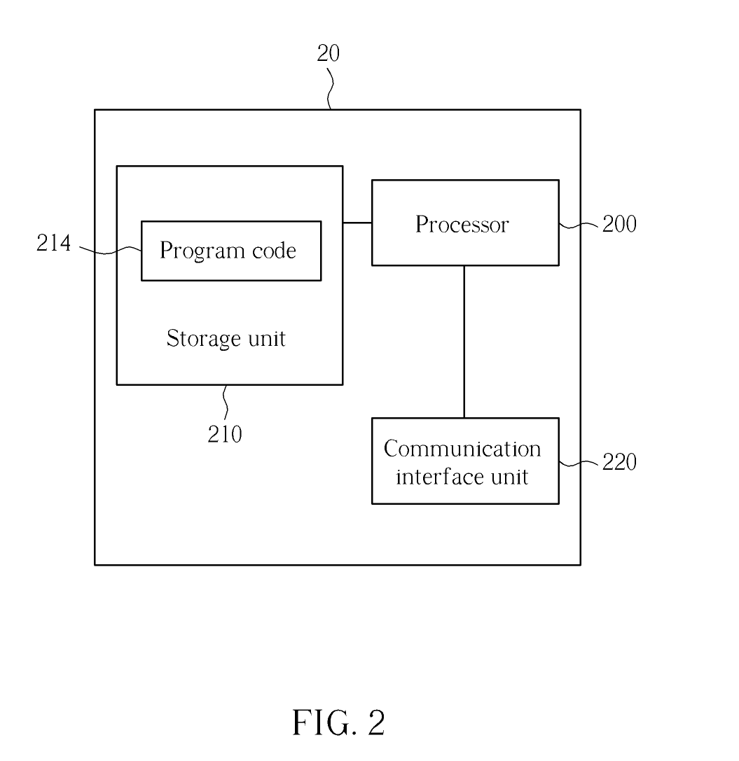

Specifically, please refer to FIG. 2, which is a schematic diagram of the mobile communication device STA shown in FIG. 1 according to an embodiment of the present invention. The mobile communication device STA includes a processor 200, such as a microprocessor or an application-specific integrated circuit (ASIC), a storage unit 210 and a communication interface unit 220. The storage unit 210 may be any data storage device for storing the program code 214 for the processor 200 to access. For example, the storage unit 210 may be a subscriber identity module (SIM), a read-only memory (ROM), a random-access memory (RAM), CD-ROMs, magnetic tapes, a hard disk or optical data storage devices, and is not limited to the mentioned storage devices. The communication interface unit 220 may be a wireless transceiver for exchanging wireless signals between the communication device 20 and the corresponding communication device according to the processing result of the processor 200.

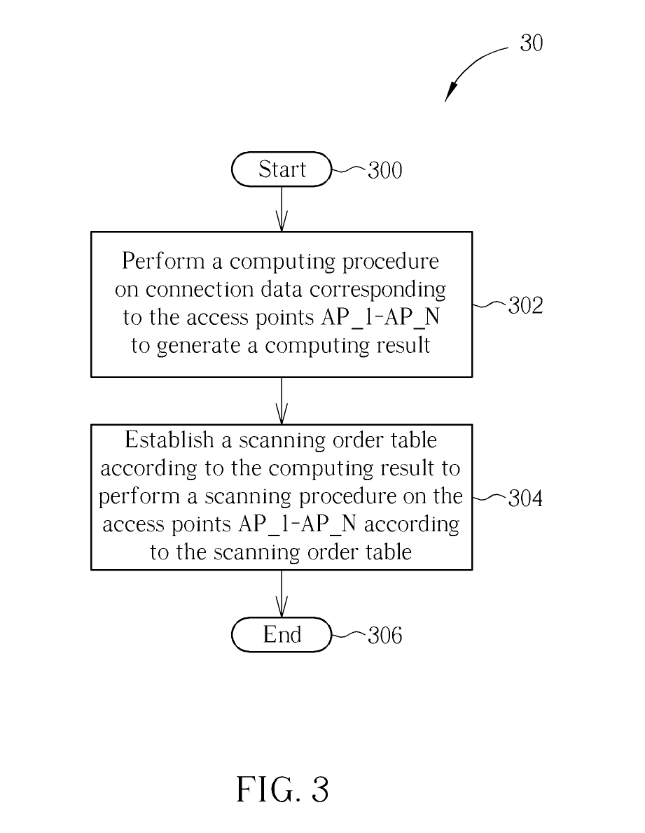

Please refer to FIG. 3, which is a schematic diagram of a process 30 according to an embodiment of the invention. The process 30 is used for generating an access points scanning order for the mobile communication device STA. The process 30 may be compiled in to the program code 214 and include the following steps:

Step 300: Start.

Step 302: Perform a computing procedure on connection data corresponding to the access points AP_{—}1-AP_N to generate a computing result.

Step 304: Establish a scanning order table according to the computing result to perform a scanning procedure on the access points AP_{—}1-AP_N according to the scanning order table.

Step 306: End.

In detail, according to the process 30, the storage unit 210 of the mobile communication device STA may further store the connection data corresponding to the access points AP_{—}1-AP_N.

For example, please refer to the following Table 1:

TABLE 1

| | | | Signal | | |
|---|---|---|---|---|---|
| Access | | | Intensity | | Link |
| Points | CH | Support Rate ((Mb/s) | Index | SSID | Times |
| AP_1 | 3 | 1, 2, 5.5, 11 | 10/94 | | 0 |
| AP_2 | 6 | 1, 2, 5.5, 11, 18, 24, | 26/94 | | 0 |
| | | 36, 54, 6, 9, 12, 48 | | | |
| AP_3 | 6 | 1, 2, 5.5, 6, 9, 11, 12, | 6/94 | | 0 |
| | | 18, 24, 36, 48, 54 | | | |
| AP_4 | 6 | 1, 2, 5.5, 11, 18, 24, | 17/94 | | 0 |
| | | 36, 54, 6, 9, 12, 48 | | | |
| AP_5 | 11 | 1, 2, 5.5, 11, 6, 9, 12, | 22/94 | | 0 |
| | | 18, 24, 36, 48, 54 | | | |
| AP_6 | 1 | 1, 2, 5.5, 11, 18, 24, | 43/94 | | 0 |
| | | 36, 54, 6, 9, 12, 48 | | | |
| AP_7 | 1 | 1, 2, 5.5, 11, 6, 9, 12, | 48/94 | 00 03 57 | 10 |
| | | 18, 24, 36, 48, 54 | | 49 53 | |
| AP_8 | 3 | 1, 2, 5.5, 11, 6, 12, | 37/94 | 00 05 53 | 1 |
| | | 24, 36, 9, 18, 48, 54 | | 61 6E 64 | |
| | | | | 79 | |
| AP_9 | 3 | 1, 2, 5.5, 11, 6, 9, 12, | 52/94 | 00 03 57 | 6 |
| | | 18, 24, 36, 48, 54 | | 4E 43 | |
| AP_10 | 6 | 1, 2, 5.5, 11, 18, 24, | 35/94 | | 0 |
| | | 36, 54, 6, 9, 12, 48 | | | |

As shown in Table 1, the connection data corresponding to the access points AP_{—}1-AP_{—}10 include at least an SSID, channel number, support rate, link times and signal intensity index. The SSID may be a Basic Service Set Identifier (BSSID) or an Extend Service Set Identifier (ESSID) based on whether the access points AP_{—}1-AP_{—}10 offer independent or interconnected network service. In other words, if the access points AP_{—}1-AP_{—}10 respectively offer independent network services, each of the access points AP_{—}1-AP_{—}10 may be regarded as a basic service set, and each of the access points AP_{—}1-AP_{—}10 has a distinct BSSID. On the other hand, if the access points AP_{—}1-AP_{—}10 are interconnected with each other and have the same ESSID, the user may roam between the access points AP_{—}1-AP_{—}10 once the user has established successful linkage with one of the access points AP_{—}1-AP_{—}10. The processor 200 compares link times of the access points AP_{—}1-AP_{—}10 according to the connection data corresponding to the access points AP_{—}1-AP_{—}10, and obtains the SSID of the access point with the highest link times. In such a situation, when the mobile communication device STA desires to perform active scanning, the SSID of the access point with the highest link times may be written into the probe request packet, e.g. Table 1 indicates access point AP_{—}7 has the highest link times, so that the mobile communication device STA may ask for a probe response only from the access point AP_{—}7, and the mobile communication device STA may obtain the probe response packet from the access point AP_{—}7 first. As a result, the mobile communication device STA may skip transmitting the broadcast probe request, which avoids the access points AP_{—}1-AP_{—}10 transmitting the probe response packet simultaneously, which reduces the probability of packet collision. Moreover, since the access point AP_{—}7 has the highest link times, it can be inferred that the user has the highest intention to link with the access point AP_{—}7, or the highest probability of successful linkage. Therefore, such a user-oriented scanning strategy may reduce the time for linking the mobile communication device to the access point.

On the other hand, the processor 200 may compute a number of supported channels of the access points AP_{—}1-AP_{—}10 according to the connection data corresponding to each of the access points AP_{—}1-AP_{—}10 in Table 1, such that the mobile communication device STA may arrange the order of the scanning channel starting from the channel used by most of the access points to the least used channel. For example, in Table 1, since there are 4 access points using channel 6, channel 6 is the most-used channel and has the first scanning priority, and the second and third scanning priority are channel 3 and channel 1. Therefore, when a scanning procedure starts, the mobile communication device STA may scan the access points AP_{—}1-AP_{—}10 based on the number of used channels. For the active scanning, the mobile communication device STA may transmit the broadcast probe request packet with channel 6 and first scan the access points using channel 6. The mobile communication device STA goes on scanning channel 3 and channel 1, and afterward the rest of the un-scanned channels, i.e. channels 2, 4, 5, and channels 7-11. Or, for the passive scanning, the mobile communication device STA may first listen to the beacon transmitted by the access points AP_{—}1-AP_{—}10 starting from channel 6, channel 3, channel 1 and the following channels 2, 4, 5, and channels 7-11. Therefore, the mobile communication device STA determines the priority of the scanning channel according to the number of channels used by the access points instead of scanning from channel 1 to channel 11. As a result, the scanning efficiency of the mobile communication device STA may be improved to shorten the time for users to access the Internet service.

According to the above description, the mobile communication device STA may first scan the frequently-used access point according to the number of link times, or the mobile communication device STA may determine the priority of the scanning channels according to the number of channels most-used by the access points as well. Moreover, the method of access point scanning order of the present invention may further take the frequently-used access point and the most-used channel number into consideration at once, or add a third scanning order condition to form a flexible and mixed scanning priority.

For example, please refer to Table 2:

TABLE 2

| | | | Signal | | | Order |
|---|---|---|---|---|---|---|
| Access | | Support Rate | Intensity | | Link | Weight- |
| points | CH | (Mb/s) | Index | SSID | Times | ing |
| AP_7 | 1 | 1, 2, 5.5, 11, | 48/94 | 00 03 57 | 10 | 0.4 |
| | | 6, 9, 12, 18, | | 49 53 | | |
| | | 24, 36, 48, 54 | | | | |
| AP_10 | 6 | 1, 2, 5.5, 11, | 35/94 | | 0 | 0.2 |
| | | 18, 24, 36, 54, | | | | |
| | | 6, 9, 12, 48 | | | | |
| AP_2 | 6 | 1, 2, 5.5, 11, | 26/94 | | 0 | 0.2 |
| | | 18, 24, 36, 54, | | | | |
| | | 6, 9, 12, 48 | | | | |
| AP_4 | 6 | 1, 2, 5.5, 11, | 17/94 | | 0 | 0.2 |
| | | 18, 24, 36, 54, | | | | |
| | | 6, 9, 12, 48 | | | | |
| AP_3 | 6 | 1, 2, 5.5, 6, 9, | 6/94 | | 0 | 0.2 |
| | | 11, 12, 18, 24, | | | | |
| | | 36, 48, 54 | | | | |
| AP_9 | 3 | 1, 2, 5.5, 11, | 52/94 | 00 03 57 | 6 | 0.1 |
| | | 6, 9, 12, 18, | | 4E 43 | | |
| | | 24, 36, 48, 54 | | | | |
| AP_8 | 3 | 1, 2, 5.5, 11, | 37/94 | 00 05 53 | 1 | 0 |
| | | 6, 12, 24, 36, | | 61 6E 64 | | |
| | | 9, 18, 48, 54 | | 79 | | |
| AP_1 | 3 | 1, 2, 5.5, 11 | 10/94 | | 0 | 0 |
| AP_6 | 1 | 1, 2, 5.5, 11, | 43/94 | | 0 | 0.1 |
| | | 18, 24, 36, 54, | | | | |
| | | 6, 9, 12, 48 | | | | |
| AP_5 | 11 | 1, 2, 5.5, 11, | 22/94 | | 0 | 0 |
| | | 6, 9, 12, 18, | | | | |
| | | 24, 36, 48, 54 | | | | |

As shown in Table 2, a column of order weighting is added for recording the order weighting corresponding to the access points AP_{—}1-AP_{—}10. Specifically, a designer may set the link times to have the highest order weighting, which is assumed to be 0.3, the channel number to have the second order weighting, which is assumed to be 0.2, and the signal intensity index to have the third order weighting, which is assumed to be 0.1. First, the order weightings of the access points AP_{—}1-AP_{—}10 are set to 0. Assuming the processor 200 of the mobile communication device STA knows that the access point AP_{—}7 has the highest link times, so as to be a frequently-used access point, the order weighting of the access point AP_{—}7 then increases by 0.3. On the other hand, since channel 6 is the most-used channel, the order weightings of the access points 2, 3, 4, 10 using channel 6 increase by 0.2. Then, the order weightings of the 3 access points with the highest signal intensity index increase by 0.1, i.e. the order weightings of the access points 6, 7, 9 increase by 0.1. Finally, total order weightings of the access points AP_{—}1-AP_{—}10 are computed, and the mobile communication device STA determines the scanning order of the access points AP_{—}1-AP_{—}10 accordingly.

As shown by the total order weightings of the access points AP_{—}1-AP_{—}10 in Table 2, when the mobile communication device STA starts the active scanning, the mobile communication device STA first transmits the probe request packet with the SSID of the access point AP_{—}7, the broadcast probe request packet of channels 6, 3, 1, 11, and the rest of the un-scanned channels. In other words, the mobile communication device STA computes different order weightings corresponding to different scanning order conditions, e.g. link times or frequently-used access points, most-used channel number and the highest signal intensity index, and takes the mentioned scanning order conditions into consideration at once to obtain a variable and flexible access points scanning priority. Thus, the efficiency of scanning access points may be improved, and the mobile communication device STA is capable of scanning the access points with which the user desires to connect, which achieves better user-friendliness.

As can be seen from the embodiments of Table 1 and Table 2, the present invention determines the priority of access points scanning order according to the link record and the connection data corresponding to different access points. Those skilled in the art may make modifications or alterations accordingly, and are not limited to this. For example, the method of determining the scanning order may be simply based on one scanning order condition, e.g. the frequently-used access point or the most-used channel; or, multiple scanning order conditions may be taken into consideration at once to obtain the variable and flexible access points scanning priority. On the other hand, the order weighting corresponding to the scanning order conditions may be adjustable. For instance, the order weighting of the signal intensity index may be increased, such that the mobile communication device STA first scans the access point with the highest signal intensity index. Furthermore, one scanning order condition may have different order weightings, e.g. by respectively setting the order weightings of three of the access points having the highest link times to be 0.6, 0.4, 0.2; or respectively setting the order weightings of the three most-used channels to be 0.3, 0.2, 0.1. As a result, the designer may change the method for calculating the order weighting to obtain the variable and flexible access points scanning priority.

Please note that the abovementioned steps including suggested steps can be realized by means that could be hardware, firmware (known as a combination of a hardware device and computer instructions and data that reside as read-only software on the hardware device), or an electronic system. Examples of hardware may include analog, digital and mixed circuits known as microcircuits, microchips, or silicon chips. Examples of the electronic system can include system on a chip (SOC), system in a package (Sip), computer on module (COM), and the communication device 20.

To sum up, the traditional method of scanning access points is for the mobile communication device to transmit the broadcast probe request from channel 1 to channel 11, which causes many access points to transmit probe response packets at the same time, leading to the increased probability of packet collision, and increases scanning time. In comparison, the mobile communication device of the present invention may first transmit the probe request packet with the specific SSID according to the number of link times to reduce the probability of packet collision, or the mobile communication device may first transmit the probe request packet from the most-used to the least-used channels to improve the efficiency of channel scanning. As a result, the mobile communication device may achieve fast and successful linkage based on the link record information, and shorten the time for users to access the Internet service.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of generating an access point scanning order for a mobile communication device in a wireless local area network, the method comprising:
performing a computing procedure on connection data corresponding to a plurality of access points to generate a computing result; and
establishing a scanning order table according to the computing result to perform a scanning procedure according to the scanning order table.

2. The method of claim 1, wherein the connection data corresponding to the plurality of access points comprises at least a set service identifier (SSID), a channel number, a support rate and a signal intensity index.

3. The method of claim 2, wherein the SSID is an extended service set identifier (ESSID) or a basic service set identifier (BSSID).

4. The method of claim 1, wherein the step of performing the scanning procedure comprises:
transmitting a probe request packet; and
receiving probe response packets from the plurality of access points.

5. The method of claim 4, wherein the probe request packet comprises one SSID or one channel number of one of the plurality of access points.

6. A mobile communication device for a wireless local area network, comprising:
a processor;
a memory, for storing a program code, the program code instructing the processor to execute the following steps:
performing a computing procedure on connection data corresponding to a plurality of access points to generate a computing result; and
establishing a scanning order table according to the computing result to perform a scanning procedure according to the scanning order table.

7. The mobile communication device of claim 6, wherein the connection data corresponding to the plurality of access points comprises at least a set service identifier (SSID), a channel number, a support rate and a signal intensity index.

8. The mobile communication device of claim 7, wherein the SSID is an extended service set identifier (ESSID) or a basic service set identifier (BSSID).

9. The mobile communication device of claim 6, wherein the step of performing the scanning procedure comprises:
transmitting a probe request packet; and
receiving probe response packets from the plurality of access points.

10. The mobile communication device of claim 9, wherein the probe request packet comprises one SSID or one channel number of one of the plurality of access points.
